(19) United States
(12) Patent Application Publication
(10) Pub. No.: US 2012/0328404 A1
(43) Pub. Date: Dec. 27, 2012

(54) INDUSTRIAL ROBOT HAVING A PROTECTION DEVICE

(75) Inventors: Thomas Froelich, Biberist (CH); Doriano Perucca, Derendingen (CH)

(73) Assignee: GUEDEL GROUP AG, Langenthal (CH)

(21) Appl. No.: 13/499,614

(22) PCT Filed: Sep. 22, 2010
(86) PCT No.: PCT/CH2010/000229

§ 371 Date: Sep. 12, 2012

(30) Foreign Application Priority Data
Oct. 1, 2009 (EP) 09 405 173.7

(51) Int. Cl. B65G 1/133

(52) U.S. Cl. 414/749.1; 901/30; 901/49

(57) ABSTRACT

The invention relates to an industrial robot, comprising a movable carriage (2, 22, 42, 52-1, 52-2), on which a working device (3.1, 23.1, 43.1) is vertically movably supported and can be lowered from a first area above a safety plane to a second area below the safety plane. A protection device is arranged in the safety plane and, in a first position, prevents the working device (3.1, 23.1, 43.1) from lowering from the first area to the second area. In a second position of the protection device, the working device (3.1, 23.1, 43.1) is able to lower to the second area. The protection device is attached to the movable carriage (2, 22, 42, 52-I, 52-2) and associated with the working device (3.1, 23.1, 43.1) such that the protection of persons and machines is ensured using a simple design.

### TECHNICAL AREA

The invention relates to an industrial robot having a movable carriage, on which a working device is mounted so it is vertically movable and can be lowered from a first region located above a safety level into a second region located below the safety level. A safety device can be positioned in a first location in the safety level in such a manner that the working device is prevented from being lowered into the second region. The safety device is movable into a second location, to allow the working device to be lowered from the first region into the second region.

### PRIOR ART

Broad possible applications exist in industry for industrial robots, for example, for gantry robots in production lines in the automobile industry, in foundries, for the charging of machine tools, in welding processes, for palletizing, or for other handling tasks. A gantry robot can comprise two support beams arranged in parallel over a floor and a support rail arranged at right angles thereto and horizontally movable on the support beams. A vertically movable working device can be attached to a horizontally movable carriage on the support rail. Using such a gantry robot, the working device can be moved to arbitrary locations of the space enclosed by the support beams and the floor.

The working device has the apparatuses required for the application, i.e., e.g., a gripper for gripping automobile parts or a welding device for performing welding processes. Thus, for example, an industrial robot can be provided to perform specific welding tasks on multiple production lines extending in parallel. For this purpose, the working device can be raised up and moved over a location of a production line. The working device can be lowered there, the required welding task can be performed, and then the working device can be raised again to move it to another location.

The space (production region) covered by an industrial robot can be very large and can contain a plurality of processing machines. For monitoring tasks, it can be necessary to enter this enclosed space during the operation of the industrial robot. In order that this is possible without danger, safety measures are necessary to prevent persons from being harmed by control errors or machine failures. Even falling small parts or oil droplets are to be prevented. The industrial robot can be controlled in such a manner that the working device of the industrial robot is only lowered at very specific locations. However, a malfunction of such a controller can have fatal consequences. Therefore, persons move within the enclosed space in danger of being touched or even injured by the moving working device.

Therefore, in the case of a carriage which is only horizontally movable along a single support rail, a U-shaped channel is arranged in the prior art, which has openings closable using a slide at the locations at which the working device must be lowered. The channel and the slides are implemented as so solid that if the slides are closed, unintentional lowering of the working device is prevented and the working device can thus be moved without danger above the U-shaped channel. Persons can thus move without danger in the space below the U-shaped channel. This space is additionally protected from falling small parts or liquid droplets.

Such a U-shaped channel must be implemented as solid, however, which requires a high structural expenditure. In addition, the cleaning of such a channel is complex.

### SUMMARY OF THE INVENTION

The object of the invention is to provide an industrial robot having a safety device, belonging to the technical field mentioned at the beginning, which is space-saving and can easily be cleaned well.

The achievement of the object is defined by the features of claim 1. According to the invention, the safety device is attached to the movable carriage of the industrial robot and is assigned to the working device of the industrial robot.

Such a safety device moves in the transport direction (i.e., transversely to the lowering direction) together with the working device and is not attached fixedly to the support beam of an industrial robot, e.g., a gantry robot. It is thus mobile. If multiple carriages having working devices, which may be moved independently of one another, are arranged on the same support beam, then a separate safety device can be attached to each carriage.

The safety device is smaller and only must be designed to catch a single working device. It can accordingly be implemented as lightweight and may be installed with less effort. The safety device is implemented as sufficiently stable so that the working device is prevented from being lowered into the region to be protected even in the event of a control error or a failure of the power supply. Finally, the safety device may be cleaned very easily, because it is designed much smaller and is therefore much better accessible than a previously known channel-shaped safety device.

A safety device according to the invention is preferably constructed from sheets or plates, so that materials such as chips or liquids can be collected. Such a safety device is used simultaneously as a lowering protector and as a drop protector. Alternatively, the safety device is implemented as a lattice, for example, and can therefore be constructed as particularly light. However, such a safety device only acts as a lowering protector or optionally as a catch protector for larger falling parts.

The carriage is preferably attached to a horizontal girder and is movable along the horizontal girder. The horizontal girder can be arranged at each of its ends on a fixedly installed column. The industrial robot can thus be moved along an axis (whose direction is defined by the horizontal girder and which can be designated, e.g., as the x-axis) and workpieces which are arranged along a line can be processed.

Alternatively, instead of being fixed on fixedly installed columns, the horizontal girder can itself be movable, for example, in that the columns are attached to rails or in that the horizontal girder is attached so it is movable at each of its ends to a crossbeam. The direction of the crossbeam can be designated as the y-axis and the working device can thus be moved or positioned in an entire spatial area (x-y plane formed by the horizontal girder and the crossbeams and the z-direction formed by the lowering direction).

The carriage to which the working device is attached can also be mounted on a rail, which forms a circular path or very generally a transport path on an arbitrary line. Alternatively, the carriage can also be mounted on one end of an extension arm or on the boom of a crane.

A downwardly protruding suspension, on which the safety device is mounted so it is rotatable, is preferably provided on the carriage (which is, e.g., a wagon having rollers). The pivoting outward and inward of the safety device can thus be ensured with a small design expenditure.

Alternatively, the safety device is mounted so it is linearly displaceable on the downwardly protruding suspension. The safety device can particularly be mounted so it is horizontally displaceable. In order that the safety device can be cleaned of materials such as chips and liquid droplets, which can collect in operation in the safety device, a stripper is provided. During a processing step, the safety device is only displaced linearly by, e.g., 80% in relation to the stripper, so that materials such as chips and liquid droplets are held back. In an emptying step, the safety device is displaced linearly by 100% and the materials are removed by the stripper from the safety device.

The safety device can preferably be moved in the first location into a first position, wherein material which has collected in the safety device is shaken out, and can be moved into a second position, wherein the collected material is held back in the safety device. Thus, in the first position, in which cleaning of the safety device can be performed by a flushing system, the collected materials can be flushed away via a surface and an edge of the safety device facing toward the floor. In the second position, in which processing of workpieces is enabled, the materials collected in the safety device, such as chips or liquid droplets, can be held back by a wall facing toward the floor.

The safety device is therefore preferably implemented as asymmetrical, in order to shake out material in the first position and hold back material in the second position.

The safety device is preferably substantially formed by a trough. The trough can comprise an inclined floor and inclined walls, so that a container is formed to be able to accommodate materials such as chips and/or liquids in a required quantity. The trough and its walls can be configured so that the materials collected in the trough are shaken out onto the floor upon pivoting out into a first position and the materials are held in the trough upon pivoting out into a second position.

Alternatively, the safety device is substantially formed by a plate. The plate can be rectangular and can comprise a border or a small fold on three of the four edges. Such a plate can have a small weight and can be used in industrial robots in which only small quantities of materials such as chips and/or liquids arise.

A flushing device is preferably arranged for flushing the safety device. The flushing device can particularly comprise a water nozzle for spraying off the safety device. Of course, the water can be preheated to a specific temperature. Solvent can also be added to the water. The water can be conducted at a high pressure to the water nozzle, so that the flushing can be performed more efficiently. The flushing device can be arranged as a washing station at any location which can be approached by the movable carriage. The flushing device can thus be arranged, for example, on one of the ends of a horizontal girder, along which the carriage is movable. The washing station is preferably arranged outside the region which must be approached by the working device in ordinary working operation.

Alternatively, a cleaning device is arranged, which cleans the safety device in a dry manner using compressed air or using rotating brushes. This has the advantage that the safety device is better protected from corrosion.

The safety device can preferably be pivoted out during the flushing or cleaning. With an asymmetrical safety device, it is particularly advantageous to pivot out the safety device into the position in which the safety device can be emptied. This has the advantage that the safety device can be cleaned particularly effectively.

A programmable control model is preferably provided for the industrial robot, in order to raise the working device into the first region located above the safety level and to pivot in the safety device, in order to move the working device over a workstation, in order to pivot out the safety device, and in order to lower the working device in the direction of the workstation. Such an industrial robot has the advantage that it can be operated without endangering persons.

Alternatively, mechanical and/or electronic means can be provided, for example, a mechanical profile attached along the horizontal girder, by which a switch is switched on or off depending on the longitudinal position of the carriage, for example, and the raising and pivoting in of the safety device are controlled accordingly. The mechanical profile can be configured according to the workstations, whereby it can be ensured that the working device is always raised between the workstations and the safety device is pivoted in. This has the advantage that two different systems can be used for the control of the work tasks of the industrial robot and the control of the safety-relevant functions.

Acoustic and/or optical means are preferably arranged to warn persons of movements of the carriage, the working device, and/or the safety device. The acoustic means can comprise a loudspeaker, a piezoelement, or a bell to generate a warning signal. The optical means can comprise a signal lamp, in particular an orange-colored, rotating, or blinking signal lamp. The safety can be additionally improved using such an industrial robot.

Preferably, at least one pneumatic drive and/or at least one electrical drive is arranged in each case for the movement of the carriage or for the pivoting in or pivoting out of the safety device, respectively. Such an industrial robot has the advantage in particular that proven and robust drives can be used for the movement of the carriage or for the pivoting in and out of the safety device, respectively.

Further advantageous embodiments and combinations of features of the invention result from the following detailed description and the entirety of the patent claims.

### BRIEF DESCRIPTION OF THE DRAWINGS

In the drawings used to explain the exemplary embodiment:

FIG. 1 shows a partial view of a gantry robot according to the prior art,

FIG. 2 shows a schematic view of an industrial robot according to the invention,

FIG. 3a shows a safety device in the first location,

FIG. 3b shows the safety device in the first position of the second location,

FIG. 3c shows the safety device in the second position of the second location,

FIG. 4a shows an industrial robot having a safety device in the first position of the second location,

FIG. 4b shows an industrial robot having a safety device in the first location, and

FIG. 5 schematically shows a facility having an industrial robot according to the invention.

Fundamentally, identical parts are provided with identical reference numerals in the figures.

### WAYS OF IMPLEMENTING THE INVENTION

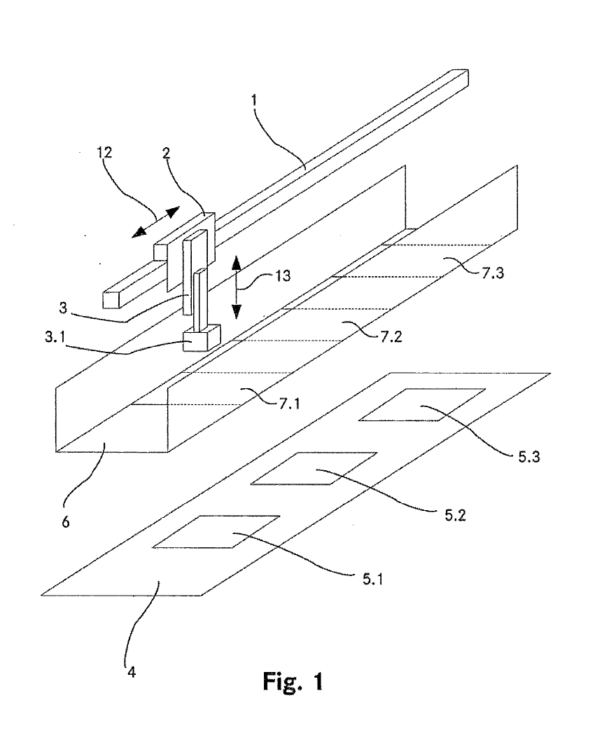

FIG. 1 schematically shows a detail of a gantry robot according to the prior art. The horizontal girder 1 is suspended on its ends (not shown), for example, in that a corresponding column is attached to the ends of the horizontal girder 1, so that the horizontal girder 1 is arranged substantially horizontally over a floor. A movable carriage 2 is attached to the horizontal girder 1. The carriage 2 can comprise rollers or wheels, for example, which cooperate with the horizontal girder 1 and whereby a horizontal movement of the carriage 2 along the horizontal girder 1 is made possible. In FIG. 1, this horizontal mobility of the carriage 2 is indicated using arrows as the horizontal displacement 12. For example, an electric motor or a pneumatic drive (not shown) can be used as the drive.

As outlined in FIG. 1, a vertical axis 3 having a working device 3.1 is attached to the carriage 2. The vertical axis 3 is configured to raise or lower the working device in the vertical direction. The vertical axis 3 can thus comprise for example, one or more profiled tubes having a toothed rack, which cooperate with gear wheels, so that the working device 3.1 attached to one profiled tube end is raised or lowered by the rotation of the gear wheels. An example of a vertical axis having additional safety is disclosed in EP 1 354 665 B1.

A processing base 4 is shown in FIG. 1, which can be formed, for example, by the floor of a workshop or by a table plate. As outlined in FIG. 1, various workstations 5.1, 5.2, 5.3 are located in the plane of the processing base 4. The workstations 5.1, 5.2, 5.3 are configured to accommodate workpieces, for example, engine or chassis parts produced in the automobile industry, for processing. Processing tools can be arranged in the workstations 5.1, 5.2, 5.3 and the working device 3.1 can be configured to grasp a workpiece, wherein the workpiece can be transported between the workstations by the displacement of the carriage 2 along the horizontal girder 1. A conveyor belt can thus be arranged in a first workstation 5.1 to guide workpieces to the industrial robot according to the invention. A workpiece can be grasped and guided to the second workstation 5.2 by the lowering of the working device 3.1 to the first workstation 5.1. In the second workstation 5.2, processing tools such as drilling tools, milling tools, welding tools, soldering tools, coolants, or any other types of apparatuses can be arranged in order to process the workpiece. After the processing, the workpiece can be grasped using the working device 3.1 and guided to the third workstation 5.3. A further conveyor belt can be arranged at the third workstation 5.3 to transport processed workpieces further.

Alternatively, the workpieces can be on three parallel conveyor belts, for example, which are arranged at an angle of 90° to the horizontal girder 1, so that workpieces can automatically be supplied on the conveyor belts to the workstations 5.1, 5.2, 5.3 and guided away again. The working device 3.1 can comprise all required apparatuses and means to perform the desired processing of a workpiece. Such apparatuses and means can comprise drilling tools, milling tools, welding tools, soldering tools, coolants, or any other types of apparatuses or means. Thus, for example, a workpiece can be guided on a conveyor belt to a workstation 5.1, 5.2, 5.3. The workstation can comprise a holder, which receives and holds a workpiece from the conveyor belt. As soon as a workpiece is held in the holder, the working device 3.1 is lowered and the workpiece is processed using a tool of the working device 3.1. The holder of the workstation is also configured to place the workpiece back on the conveyor belt after the processing.

As outlined in FIG. 1, a channel 6 is arranged in a plane between the horizontal girder 1 and the processing base 4. The channel 6 comprises closable shafts 7.1, 7.2, 7.3. One workstation 5.1, 5.2, 5.3 is assigned to each closable shaft 7.1, 7.2, 7.3. The channel 6 can be arranged at a height of 220 cm, so that persons can move through comfortably below it, and can be 80 cm wide and equally tall. The channel 6 is secure against breakthrough of parts falling down or against the unintentional lowering of the working device 3.1. Using such a channel, it is ensured that persons who are located, for example, for monitoring tasks in proximity to or between the workstations are protected from falling parts. Various chips or liquid residues of coolants can remain adhering to the working device 3.1 after the processing of a workpiece. During the displacement of the working device 3.1 above the channel 6, these chips or liquid residues can fall or drip down. The channel 6 must therefore be liquid-tight so that the channel 6 can be flushed out for cleaning purposes.

A safety level is defined by the channel 6, wherein the working device 3.1 is movable in a first region above the safety level along the horizontal girder 1, and wherein the working device can be lowered into a second region below the safety level after the opening of a shaft 7.1, 7.2, 7.3. The channel 6 arranged in the safety level causes comprehensive protection of persons and machines who are located in the second region below the safety level.

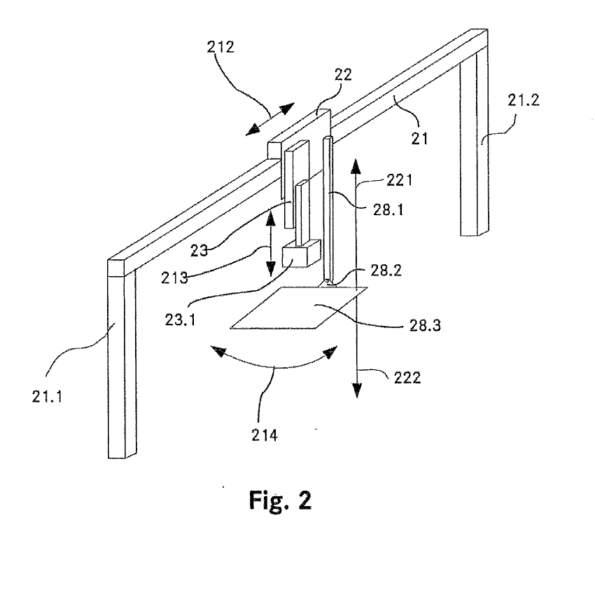

FIG. 2 schematically shows a partial detail of an industrial robot according to the invention. A horizontal girder 21 is supported at its ends, for example, by corresponding columns 21.1, 21.2. For example, the horizontal girder 21 can be arranged over a floor of a workshop. The distance between the horizontal girder 21 and the floor can be between 250 cm and 280 cm, for example. A movable carriage 22 is attached to the horizontal girder 21. The carriage 22 can comprise rollers or wheels, which are supported on the horizontal girder 21 and are configured to move the carriage 22 horizontally along the horizontal girder 21. For this purpose, suitable drives, such as an electric drive or a pneumatic drive (not shown), can be attached to the carriage 22 or to the horizontal girder 21.

A vertical axis 23 is attached to the carriage 22 in order to raise or lower a working device 23.1. The vertical axis 23 can be implemented according to the prior art and can be formed, for example, from one or more rods displaceable in relation to the carriage 22, from profiles, or from plates. The drive of the vertical axis can again be electrical or pneumatic (not shown).

As sketched in FIG. 2, a safety device consisting of a protective plate 28.3, a rotational axis 28.2, and a suspension 28.1 is arranged on the carriage 22. The suspension 28.1 is fixedly connected at one end to the carriage 22, for example, using screw connections. At the other end of the suspension 28.1, a rotational axis 28.2 is attached, which carries a protective plate 28.3. The protective plate 28.3 can be rotated by a drive (not shown) around the rotational axis 28.2 and therefore pivoted in or pivoted out below the working device 23.1 according to the rotational direction 214. The protective plate 28.3 is sketched in the first, pivoted-in location in FIG. 2, whereby a safety level is defined. In this first location, the working device 23.1 is prevented from being lowered from the first region 221 above the safety level into the second region 222 located below the safety level. The safety device consisting of the protective plate 28.3, the rotational axis 28.2, and the suspension 28.1 can be dimensioned so that it is breakthrough-safe and the lowering of the working device 23.1 is prevented in the pivoted-in state. The protective plate 28.3 is preferably designed in the form of a trough, so that chips falling down or liquids dripping down from the working device 23.1 are collected in the trough-shaped protective plate 28.3.

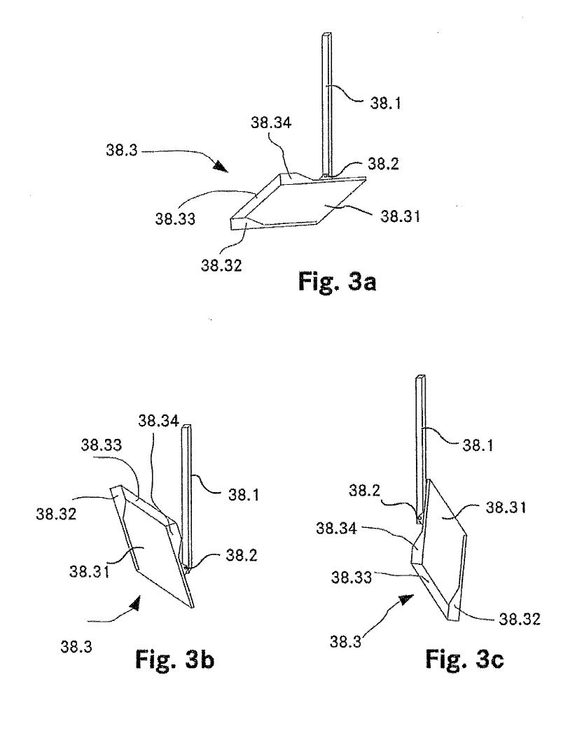

FIG. 3a shows a trough-shaped protective plate 38.3 in a first, pivoted-in location. The trough-shaped protective plate 38.3 can comprise a floor 38.31 as sketched in FIG. 3a. Three walls 38.32, 38.33, 38.34 are attached on three sides on the edge of the floor 38.31. No wall is attached on the fourth side of the edge of the floor. The three walls 38.32, 38.33, 38.34 can be of different heights as sketched in FIG. 3a, so that a taller wall 38.33 is attached on one side of the floor 38.31. As sketched in FIG. 3a, the floor of the protective plate 38.3 can be inclined slightly toward the taller wall 38.33 in the first, pivoted-in position. Through this inclination, chips or liquid droplets which are accommodated by the protective plate 38.3 are guided to the taller wall 38.33 and do not fall down over the edge of the floor of the protective plate 38.3 to which no wall is attached. Such a trough-shaped protective plate 38.3 is constructed asymmetrically.

In FIG. 3b, the protective plate 38.3 is sketched in a first position of the pivoted-out location. In this first pivoted-out position, no wall 38.32, 38.33, 38.34 of the protective plate 38.3 faces toward the floor. Chips and liquid droplets which have collected on the protective plate 38.3 thus fall down onto the workshop floor. In this position, the trough-shaped protective plate 38.3 can be cleaned particularly easily and thoroughly using a flushing device, in that in particular the floor 38.31 is cleaned using a water jet and/or using brushes.

In FIG. 3c, the protective plate 38.3 is sketched in a second position of the pivoted-out location. In this second pivoted-out position, a tall wall of the protective plate 38.3 faces toward the floor. Chips and liquid droplets which have collected on the protective plate 38.3 are held by this tall wall and do not fall down onto the floor. This position is suitable for the purpose of lowering the working device using the vertical axis over a workstation and ensuring that chips and liquids collected on the protective plate 38.3 do not fall or drip onto workstations.

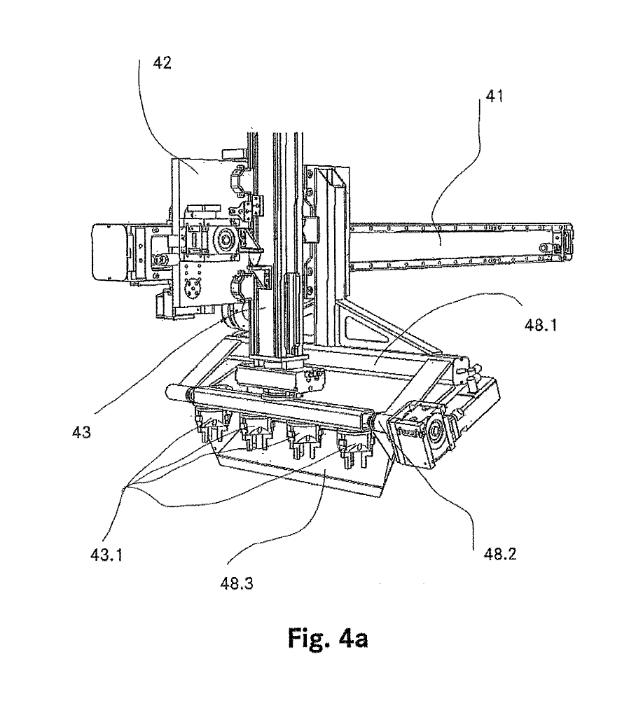

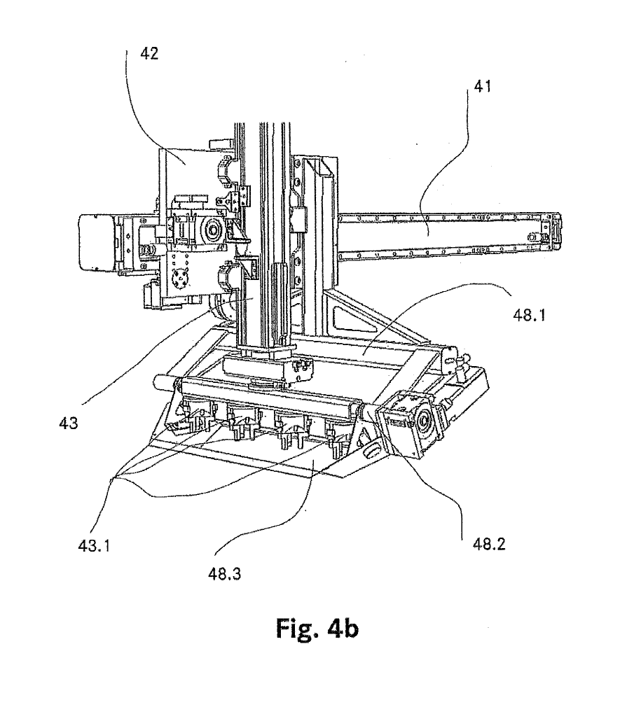

An embodiment variant of an industrial robot according to the invention is shown in FIG. 4a. A horizontal girder 41 is arranged, for example, horizontally over the floor of a workshop. The horizontal girder 41 can be fixedly installed on corresponding columns, for example. The horizontal girder 41 can alternatively be installed on corresponding crossbeams, in such a manner that the horizontal girder 41 can be moved along these crossbeams. As shown in FIG. 4a, a carriage 42 is attached to the horizontal girder 41. The carriage 42 can comprise electric motors or pneumatic drives to move the carriage 42 along the horizontal girder 41. The carriage 42 can therefore be moved parallel to the axis formed by the carriage 42 or alternatively parallel to the plane formed by the carriage 42 and the crossbeam.

As shown in FIG. 4a, a vertical axis 43 is attached to the carriage 42. The vertical axis 43 can comprise a toothed rack, for example, which cooperates with gear wheels attached to the carriage 42 and thus allows a vertical movement of the vertical axis 43. The gear wheels can be driven by an electrical or pneumatic drive. A working device 43.1 is attached to one end of the vertical axis 43. As shown in FIG. 4a, the working device 43.1 can comprise multiple tools. The working device 43.1 can comprise, for example, three-jaw grippers or any other type of gripping device, in order to grasp individual parts and release them again. Thus, using a three-jaw gripper, in particular disk parts can be grasped or released, in that the three-jaw gripper grasps from the inside in an opening such as a borehole of the disk part. On the other hand, the working device 43.1 can be configured, for example, in the case of a four-cylinder automobile engine to perform a processing step such as the cleaning of the cylinder inner faces simultaneously for the four cylinders. Of course, the working device 43.1 can comprise an arbitrary number of identical or different tools.

As shown in FIG. 4a, a suspension 48.1 is fastened on the carriage 42. The suspension 48.1 can be produced from hollow profiles, for example. A rotational axis 48.2 is attached to the suspension 48.1. A protective plate 48.3 is attached to the rotational axis 48.2. The protective plate 48.3 can be pivoted into different locations around the rotational axis 48.2 by means of a drive. In FIG. 4a, the protective plate 48.3 is shown in a pivoted-out location, so that the working device 43.1 is released for processing a workpiece and can be lowered.

In FIG. 4b, the protective plate 48.3 is shown in a first, pivoted-in location, so that the working device 43.1 cannot be lowered and in particular chips or liquid droplets which can adhere to the working device 43.1 and fall down are collected in the protective plate 48.3.

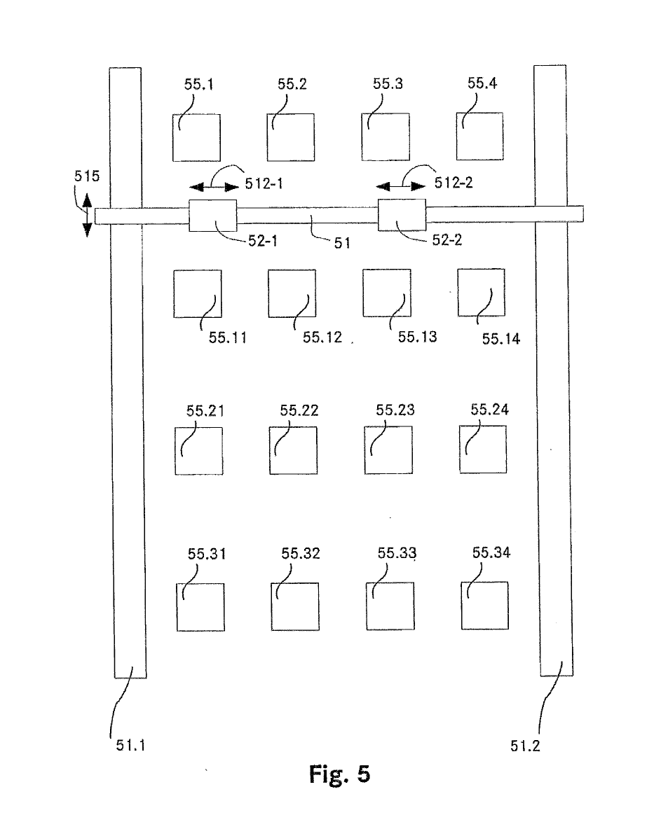

FIG. 5 schematically shows the top view of a facility having an industrial robot according to the invention. The facility sketched in FIG. 5 comprises a total of sixteen workstations 55.1, 55.2, 55.3, . . . 55.34. Of course, facilities can be constructed having more or fewer workstations 55.1, . . . , 55.34. The facility comprises two crossbeams 52.1, 52.2, which are attached over the floor of a workshop. A horizontal girder 51 is attached to the crossbeams 52.1, 52.2, the horizontal girder being movable on the crossbeams 52.1, 52.2 in the transverse displacement directions 515. Two carriages 52-1, 52-2 are attached to the horizontal girder 51, which are movable along the horizontal girder in the horizontal displacement directions 512-1, 512-2. Depending on the size of the facility, of course, an arbitrary number of carriages can be attached to the horizontal girder 51. The carriages 52-1, 52-2 can comprise means to prevent or at least damp unintentional collisions. As described above, a vertical axis having a working device and a safety device having a suspension, a rotational axis, and a protective plate are attached to each of the carriages 52-1, 52-2. A working device can be moved, for example, over a workstation 55.1 by a corresponding transverse displacement of the horizontal girder 51 and a horizontal displacement of the carriage 52-1. The protective plate can be pivoted out and the working device can be lowered in the direction of the workstation in order to grasp or process a workpiece, for example. Simultaneously, the carriage 52-2 can also be moved over the workstation 55.3 to perform similar lowering of a working device. The working devices can then be raised and the working devices can be moved over other workstations, for example, over the workstations 55.12 and 55.14, by a movement of the carriages 52-1, 52-2 and/or a movement of the horizontal girder 51. Using such a facility, the workstations 55.1, . . . , 55.34 can be supplied with workpieces and efficient processing of workpieces can be performed, with simultaneous optimum protection and safety of persons who are located or are moving in the region between the workstations 55.1, . . . , 55.34.

Alternatively, the suspension 28.1 can be attached together with the protective plate 28.3 and the rotational axis 28.2 directly above the working device 23.1, instead of to the carriage 22. This has the result that the protective plate 28.3 is raised or lowered simultaneously with the working device 23.1. The protective plate 28.3 can be pivoted out before the lowering, so that the working device 23.1 can be used to accommodate or process a workpiece. After the accommodation or processing of the workpiece, the working device 23.1 can be raised and the protective plate 28.3 can be pivoted in. Chips and liquid residues which detach from the working device 23.1 can thus be accommodated by the protective plate 28.3. To protect persons, however, a safety controller must be used in this case in connection with a redundant safety brake, for example, according to EP 1 354 665 B1 (Güdel Group AG). It is therefore ensured that unintentional lowering of the working device 23.1 cannot occur. The execution and periodic function testing must meet the standards of ISO 13849-1 and must achieve corresponding performance levels.

Instead of a facility according to FIG. 5, a rail system can also be provided, which is arranged above workstations and allows the movement of a carriage having attached working device and safety device above the workstations. Such a rail system can particularly comprise arbitrary curves, bends, and/or switches, so that rapid and efficient movement of the carriage is possible.

In summary, it can be stated that an industrial robot having a safety device is provided by the invention, wherein a small design expenditure is necessary and the safety device can be easily cleaned.

1-10. (canceled)

11. An industrial robot having a movable carriage, on which a working device is mounted so it is vertically movable and can be lowered from a first region located above a safety level into a second region located below the safety level, wherein a safety device can be positioned in a first location in the safety level in such a manner that the working device is prevented from being lowered into the second region, and wherein the safety device is movable into a second location, to allow the working device to be lowered from the first region into the second region, wherein the safety device is attached to the movable carriage and is assigned to the working device, characterized in that a suspension, on which the safety device is mounted so it is rotatable on a rotational axis, is arranged on the carriage.

12. The industrial robot as claimed in claim 11, characterized in that the carriage is attached to a horizontal girder and is movable along the horizontal girder.

13. The industrial robot as claimed in claim 11, characterized in that the safety device is implemented as asymmetrical and in the second location can be moved into a first position, wherein material which has collected in the safety device is shaken out, and can be moved into a second position, wherein the collected material is held in the safety device.

14. The industrial robot as claimed in claim 11, characterized in that the safety device is substantially formed by a trough.

15. The industrial robot as claimed in claim 11, characterized in that a flushing device is arranged for flushing the safety device.

16. The industrial robot as claimed in claim 15, characterized in that the safety device can be pivoted out during the flushing.

17. The industrial robot as claimed in claim 11, characterized in that it is configured in order to raise the working device into the first region located above the safety level and to pivot in the safety device, in order to move the working device over a workstation, in order to pivot out the safety device, and in order to lower the working device in the direction of the workstation.

18. The industrial robot as claimed in claim 11, characterized in that acoustic and/or optical means are arranged to warn persons of movements of the carriage, the working device, and/or the safety device.

19. The industrial robot as claimed in claim 11, characterized in that at least one pneumatic drive and/or at least one electrical drive is arranged for the movement of the carriage or for the pivoting in or pivoting out of the safety device, respectively.
